(19) United States
(12) Patent Application Publication
(10) Pub. No.: US 2024/0199892 A1
(43) Pub. Date: Jun. 20, 2024

(54) HYDROPHOBIC AND SUPERHYDROPHOBIC COATINGS AND METHOD OF MAKING AT ROOM TEMPERATURE

(71) Applicant: Technology Innovation iInstitute = Sole Proprietorship LLC, Masdar City (AE)

(72) Inventors: Zineb Matouk, Masdar City (AE); Abdulla Al Shehhi, Masdar City (AE); Monserrat gutierrez Munoz, Abu Dhabi (AE); Shroq Al Zadjali, Masdar City (AE); Eva Correia, Abu Dhabi (AE); Afra Saeed Mubarak Jezaie Alketbi, Sharjah (AE)

(73) Assignee: Technology Innovatin Institute - Sole Proprietorship LLC, Masdar Ciry (AE)

(21) Appl. No.: 18/390,023

(22) Filed: Dec. 20, 2023

Related U.S. Application Data
(60) Provisional application No. 63/476,279, filed on Dec. 20, 2022.

(51) Int. Cl. C09D 5/16; C09D 7/40; C09D 7/41; C09D 7/62; C09D 129/10; C08K 9/00

(52) U.S. Cl. CPC C09D 5/1668; C09D 5/1618; C09D 7/41; C09D 7/62; C09D 7/67; C09D 129/10; C08K 9/00; C08K 2201/011

(57) ABSTRACT

The present disclosure provides coating compositions which are transparent and hydrophobic or superhydrophobic. The coating composition may include a compound with hydrophobic moieties and a transparent binder. Methods of preparing such coatings at room temperature are also provided, along with methods of providing a transparent and hydrophobic or superhydrophobic coating to a surface. The coating compositions of the present disclosure may exhibit a transparency of at least about 95%.

### CROSS-REFERENCE TO RELATED APPLICATIONS

This application claims priority to U.S. Provisional Patent Application No. 63/476,279, which was filed on Dec. 20, 2022, the entire contents of which are incorporated by reference herein.

### FIELD

The present disclosure relates generally to hydrophobic and superhydrophobic and transparent coatings. Methods of making such coatings at room temperature are also described.

### BACKGROUND

The implementation of water and dust repellent coatings on surfaces presents numerous distinct advantages. These coatings facilitate simplified maintenance and cleaning processes, while simultaneously enhancing durability through the mitigation of water and abrasion-induced damage. Furthermore, they uphold a consistently desirable aesthetic appeal. Moreover, the application of hydrophobic coatings offers potential environmental benefits by promoting water conservation and resource optimization. With their adaptability for deployment across a diverse array of materials, these coatings offer versatile solutions for a broad spectrum of industries and applications. Externally exposed materials and surfaces are typically not hydrophobic and may be damaged by prolonged water or dust exposure. Further, it is necessary in some applications that the surface is not obscured by an opaque coating, which limits the range of coating materials which may be used. It is thus desirable to produce a transparent coating that is capable of protecting sensitive surfaces from exposure-related damage while maintaining the appearance and performance of photo-active devices such as solar panels.

Producing transparent, hydrophobic and superhydrophobic coating materials is highly desirable. Additionally, there is a necessity for room temperature processed coatings which are easy to apply, stable, and compatible with a variety of surface materials.

### SUMMARY

In aspects, the techniques described herein relate to a coating composition, including: a hydrophobic compound; a binder; and a solvent; wherein the coating composition is hydrophobic and transparent; and wherein the coating composition is processable at room temperature.

In aspects, the techniques described herein relate to a coating composition, wherein the hydrophobic compound includes silicon dioxide nanostructures, titanium dioxide nanostructures, zinc oxide nanostructures, aluminum oxide nanostructures, aluminosilicates, dimethyldiethoxysilane, trimethylethoxysilane, bis(trimethylsilyl) amine, isooctyltriethoxysilane, octadecyltriethoxysilane, dodecyldimethylethoxysilane, (3,3,3-trifluoropropyl) trimethoxysilane, (heptadecafluoro-1,1,2,2-tetrahydrodecyl) triethoxysilane, or combinations thereof.

In aspects, the techniques described herein relate to a coating composition according to any of the above aspects, wherein the coating composition includes 0.01 wt. % to 7 wt. % of the hydrophobic compound.

In aspects, the techniques described herein relate to a coating composition according to any of the above aspects, wherein the binder includes a fluoropolymer, an organically modified silicate, a functional polydimethylsiloxane copolymer, or combinations thereof.

In aspects, the techniques described herein relate to a coating composition according to any of the above aspects, wherein the binder includes fluoroethylene vinyl ether, polyvinyl fluoride, polyvinylidene fluoride, tetrafluoroethylene, hexafluoropropylene, vinylidene fluoride, hexafluoropropylene, tetrafluoroethylene, ethylene, tetraethoxysilane, methyltriethoxysilane, dimethyldiethoxysilane, silanol terminated polydimethylsiloxane, epoxypropoxypropyl terminated polydimethylsiloxane, aminopropyl terminated polydimethylsiloxane, ethoxy terminated polydimethylsiloxane, hydride terminated polydimethylsiloxane, or combinations thereof.

In aspects, the techniques described herein relate to a coating composition according to any of the above aspects, wherein the coating composition includes 10 wt. % to 90 wt. % of the binder.

In aspects, the techniques described herein relate to a coating composition according to any of the above aspects, wherein the solvent includes N-methylpyrrolidone, N-dimethylformamide, N,N-dimethylacetamide, xylene, n-butyl acetate, t-butyl acetate, p-chlorobenzotrifluoride, acetone, dimethyl carbonate, propylene carbonate, methyl ethyl ketone, methyl amyl ketone, methyl propyl ketone, methyl butyl ketone, 1-methoxy-2-propyl acetate, ethyl 3-ethoxy propionate, ethylene glycol monopropyl ether, ethyl acetate, methyl acetate, water, methanol, ethanol, propanol, isopropanol, butanol, butyl acetate, or combinations thereof.

In aspects, the techniques described herein relate to a coating composition according to any of the above aspects, wherein the coating composition includes about 10 wt. % to about 90 wt. % of the solvent.

In aspects, the techniques described herein relate to a coating composition according to any of the above aspects, wherein the coating composition has a contact angle between greater than or equal to 90° and less than or equal to 180°.

In aspects, the techniques described herein relate to a coating composition according to any of the above aspects, wherein the coating composition is superhydrophobic.

In aspects, the techniques described herein relate to a coating composition according to any of the above aspects, wherein the coating composition is at least 95% transparent.

In aspects, the techniques described herein relate to a method of making a coating composition, including: providing a binder and a hydrophobic compound; and preparing a coating solution including the binder, the hydrophobic compound, and a solvent.

In aspects, the techniques described herein relate to a method, wherein the binder includes fluoroethylene vinyl ether, polyvinyl fluoride, polyvinylidene fluoride, tetrafluoroethylene, hexafluoropropylene, vinylidene fluoride, hexafluoropropylene, tetrafluoroethylene, ethylene, tetraethoxysilane, methyltriethoxysilane, dimethyldiethoxysilane, silanol terminated polydimethylsiloxane, epoxypropoxypropyl terminated polydimethylsiloxane, aminopropyl terminated polydimethylsiloxane, ethoxy terminated polydimethylsiloxane, hydride terminated polydimethylsiloxane, or combinations thereof.

In aspects, the techniques described herein relate to a method according to any of the above aspects, wherein the hydrophobic compound includes silicon dioxide nanostructures, titanium dioxide nanostructures, zinc oxide nanostructures, aluminum oxide nanostructures, aluminosilicates, dimethyldiethoxysilane, trimethylethoxysilane, bis(trimethylsilyl) amine, isooctyltriethoxysilane, octadecyltriethoxysilane, dodecyldimethylethoxysilane, (3,3,3-trifluoropropyl) trimethoxysilane, (heptadecafluoro-1,1,2,2-tetrahydrodecyl) triethoxysilane, or combinations thereof.

In aspects, the techniques described herein relate to a method according to any of the above aspects, wherein the solvent includes N-methylpyrrolidone, N-dimethylformamide, N,N-dimethylacetamide, xylene, n-butyl acetate, t-butyl acetate, p-chlorobenzotrifluoride, acetone, dimethyl carbonate, propylene carbonate, methyl ethyl ketone, methyl amyl ketone, methyl propyl ketone, methyl butyl ketone, 1-methoxy-2-propyl acetate, ethyl 3-ethoxy propionate, ethylene glycol monopropyl ether, ethyl acetate, methyl acetate, water, methanol, ethanol, propanol, isopropanol, butanol, butyl acetate, or combinations thereof.

In aspects, the techniques described herein relate to a method according to any of the above aspects, further including preparing a hydrophobic solution including the hydrophobic compound and the solvent.

In aspects, the techniques described herein relate to a method according to any of the above aspects, wherein preparing the coating solution includes combining the binder with the hydrophobic solution.

In aspects, the techniques described herein relate to a method according to any of the above aspects, further including preparing a binder solution including the binder and the solvent.

In aspects, the techniques described herein relate to a method according to any of the above aspects, wherein preparing the coating solution includes combining the hydrophobic compound with the binder solution.

In aspects, the techniques described herein relate to a method according to any of the above aspects, wherein preparing the coating solution includes combining a solution of the binder in the solvent with a solution of the hydrophobic compound in the solvent.

In aspects, the techniques described herein relate to a method according to any of the above aspects, wherein preparing the coating solution includes combining the binder and the hydrophobic compound in the solvent.

In aspects, the techniques described herein relate to a method of providing a transparent and hydrophobic coating to a surface, including: applying a coating composition which includes a hydrophobic compound, a binder, and a solvent to the surface.

In aspects, the techniques described herein relate to a method, wherein the surface includes a metal, a metallic alloy, glass, plastic, ceramics, polymer, fabrics, wood, concrete, or combinations thereof.

In aspects, the techniques described herein relate to a method according to any of the above aspects, wherein the hydrophobic compound includes silicon dioxide nanostructures, titanium dioxide nanostructures, zinc oxide nanostructures, aluminum oxide nanostructures, aluminosilicates, dimethyldiethoxysilane, trimethylethoxysilane, bis(trimethylsilyl) amine, isooctyltriethoxysilane, octadecyltriethoxysilane, dodecyldimethylethoxysilane, (3,3,3-trifluoropropyl) trimethoxysilane, (heptadecafluoro-1,1,2,2-tetrahydrodecyl) triethoxysilane, or combinations thereof.

In aspects, the techniques described herein relate to a method according to any of the above aspects, wherein the binder includes fluoroethylene vinyl ether, polyvinyl fluoride, polyvinylidene fluoride, tetrafluoroethylene, hexafluoropropylene, vinylidene fluoride, hexafluoropropylene, tetrafluoroethylene, ethylene, tetracthoxysilane, methyltriethoxysilane, dimethyldiethoxysilane, silanol terminated polydimethylsiloxane, epoxypropoxypropyl terminated polydimethylsiloxane, aminopropyl terminated polydimethylsiloxane, ethoxy terminated polydimethylsiloxane, hydride terminated polydimethylsiloxane, or combinations thereof.

In aspects, the techniques described herein relate to a method according to any of the above aspects, wherein the solvent includes N-methylpyrrolidone, N-dimethylformamide, N,N-dimethylacetamide, xylene, n-butyl acetate, t-butyl acetate, p-chlorobenzotrifluoride, acetone, dimethyl carbonate, propylene carbonate, methyl ethyl ketone, methyl amyl ketone, methyl propyl ketone, methyl butyl ketone, 1-methoxy-2-propyl acetate, ethyl 3-ethoxy propionate, ethylene glycol monopropyl ether, ethyl acetate, methyl acetate, water, methanol, ethanol, propanol, isopropanol, butanol, butyl acetate, or combinations thereof.

In aspects, the techniques described herein relate to a method according to any of the above aspects, wherein applying the coating composition to the surface includes roll coating, drop rolling, spraying, dip coating, blade coating, flow coating, spin-coating, aerosol deposition, ultrasound deposition, electrical deposition, inkjet printing, spray-jet printing, xerography, silk printing, dot matrix printing, or combinations thereof.

In aspects, the techniques described herein relate to a method according to any of the above aspects, wherein the coating composition is applied at room temperature.

In aspects, the techniques described herein relate to a method according to any of the above aspects, wherein the coating composition is superhydrophobic.

### BRIEF DESCRIPTION OF THE DRAWINGS

Aspects, features, benefits, and advantages of the embodiments described herein will be apparent with regard to the following description, appended claims, and accompanying drawings where:

FIG. 1 is a flow chart of a method of making and depositing a coating solution at room temperature, according to an embodiment of the present disclosure.

FIG. 2A is an image of a water droplet on nonfunctionalized nanoparticles and FIG. 2B is an image of a water droplet on functionalized nanoparticles with hydrophobic moieties, according to embodiments of the present disclosure.

FIG. 3A is an image of a water droplet on a bare glass substrate, FIG. 3B is an image of a water droplet on a glass substrate coated with a hydrophobic coating, and FIG. 3C is an image of a water droplet on a glass substrate coated with a superhydrophobic coating composition, demonstrating the contact angle, according to embodiments of the present disclosure.

FIG. 4 is a graph of transmittance (%) of bare glass compared to a glass with a single- and double-layered coating as described herein, according to an embodiment of the present disclosure.

FIG. 5A is a scanning electron microscopy (SEM) image of the top morphology of a representative sample of a hydrophobic coating prepared with a fluoropolymer-based binder, and FIG. 5B is an SEM image of the top morphology of a representative sample of a hydrophobic coating prepared with an organically modified silica-based binder, according to embodiments of the present disclosure.

FIG. 6 is an atomic force microscopy (AFM) image of the top morphology of a representative sample of a coating at nanometer and micrometer scale, according to an embodiment of the present disclosure.

FIG. 7 is an X-ray photoelectron spectroscopy (XPS) spectra of a representative single layered sample of a coating, according to an embodiment of the present disclosure.

FIG. 8 is an image of the dust-repellence effect of a representative sample of a coating according to an embodiment of the present disclosure, compared to a bare glass and glass coated with hydrophobic commercial coatings over a certain period of outdoor exposure.

### DETAILED DESCRIPTION

The present disclosure describes hydrophobic and superhydrophobic transparent coating compositions which can include a hydrophobic moiety, a binder, and a solvent. The coating compositions can be applied easily to a range of substrates including, but not limited to, glass, metal, or plastic. The coating can be applied with a spray coater or with dip coating methods and dried at room temperature. The coating compositions may be applied to devices and surfaces including solar panels, wind turbine surfaces, home exteriors, vehicles, and aerospace products. The coating compositions described herein effectively repel dust particles and fluids such as water which may negatively impact the performance of surfaces.

In embodiments, the present disclosure contemplates coatings which are transparent and hydrophobic or superhydrophobic. In this context, the term “superhydrophobic” denotes the quality of being exceedingly hydrophobic, or very difficult to wet; that is, a superhydrophobic coating on a surface imparts superhydrophobicity to the surface. It is known in the art that measuring the contact angle created by a liquid droplet on a solid substrate's surface is a quantitative indicator of the solid's wetting capacity. Wetting is the ability of a liquid to sustain contact with a solid surface. A balance of adhesive and cohesive forces determines the degree of wetting, also known as wettability. Where a liquid/vapor interface meets a solid surface, the contact is typically assessed through the liquid and measures the wettability of a solid surface by a liquid.

A substance is typically regarded as hydrophobic if the water droplet's contact angle with the substrate surface is larger than 90°. A superhydrophobic coating is one with a water droplet contact angle of at least 150°, which is desirable for many applications. The angle between a static drop of deionized water and a horizontal surface is referred to as the “contact angle” or “static contact angle”, as will be familiar to those skilled in the art and used throughout this document. The hydrophobic interaction between the surface and the liquid increases with increasing contact angle. The angle between the sample surface and the horizontal plane at which a liquid drop begins to roll off the sample surface due to gravity is known as the sliding angle or roll-off angle. The contact angle is zero degrees(0°) if a liquid forms a film and spreads evenly across the surface. The wetting resistance rises with increasing contact angle, reaching a theoretical maximum at 180°, where liquid forms spherical drops on the surface. Surfaces with a strong wetting resistance to a certain reference liquid are referred to as “wet-proof,” while surfaces with water as the reference liquid are referred to as “hydrophobic.” The hydrophobic interaction between the surface and the liquid increases with increasing contact angle.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55% and also discloses exactly 50%. Stated differently, any value disclosed herein as being modified by “about” also discloses the exact value.

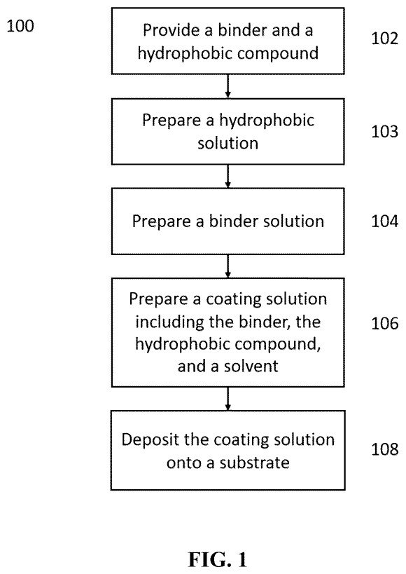

In embodiments, there is provided a method of making a coating composition which is transparent and hydrophobic or superhydrophobic. FIG. 1 is a flow chart of a method of making a transparent coating that is transparent and hydrophobic or superhydrophobic, according to an embodiment of the present disclosure. The method 100 may include a step 102 of providing a binder and a hydrophobic compound, an optional step 103 of preparing a hydrophobic solution, an optional step 104 of preparing a binder solution, a step 106 of preparing a coating solution including the binder, the hydrophobic compound, and a solvent, and an optional step 108 of depositing the coating solution onto a substrate.

In embodiments, the method includes step 102 of providing a binder and a hydrophobic compound. The binder and the hydrophobic compound may be obtained from any source and provided in any form that such compounds are available. In embodiments, the binder includes fluoroethylene vinyl ether, polyvinyl fluoride, polyvinylidene fluoride, tetrafluoroethylene, hexafluoropropylene, vinylidene fluoride, hexafluoropropylene, tetrafluoroethylene, ethylene, tetracthoxysilane, methyltriethoxysilane, dimethyldiethoxysilane, silanol terminated polydimethylsiloxane, epoxypropoxypropyl terminated polydimethylsiloxane, aminopropyl terminated polydimethylsiloxane, ethoxy terminated polydimethylsiloxane, hydride terminated polydimethylsiloxane, or combinations thereof. In embodiments, the hydrophobic compound may include silicon dioxide nanostructures, titanium dioxide nanostructures, zinc oxide nanostructures, aluminum oxide nanostructures, aluminosilicates, dimethyldiethoxysilane, trimethylethoxysilane, bis(trimethylsilyl) amine, isooctyltriethoxysilane, octadecyltriethoxysilane, dodecyldimethylethoxysilane, (3,3,3-trifluoropropyl) trimethoxysilane, (heptadecafluoro-1,1,2,2-tetrahydrodecyl) triethoxysilane, or combinations thereof.

In embodiments, the method includes step 103 of preparing a hydrophobic solution. The hydrophobic solution may include the hydrophobic compound, such as a composition having hydrophobic moieties. In embodiments, the hydrophobic compound may include silicon dioxide nanostructures, titanium dioxide nanostructures, zinc oxide nanostructures, aluminum oxide nanostructures, aluminosilicates, dimethyldiethoxysilane, trimethylethoxysilane, bis(trimethylsilyl) amine, isooctyltriethoxysilane, octadecyltriethoxysilane, dodecyldimethylethoxysilane, (3,3,3-trifluoropropyl) trimethoxysilane, (heptadecafluoro-1,1,2,2-tetrahydrodecyl) triethoxysilane, or combinations thereof. Nanostructures may include nanoparticles, nanorods, nanowires, nanoflakes, combinations thereof, and other nanometer-scale structures familiar to those skilled in the art.

Preparing the hydrophobic solution may include dispersing the hydrophobic compound in a solvent. The solvent allows the hydrophobic moieties to evenly disperse to form a uniform and homogenous coating composition, without wishing to be bound by theory. In embodiments, the solvent may include N-methylpyrrolidone, N-dimethylformamide, N,N-dimethylacetamide, xylene, n-butyl acetate, t-butyl acetate, p-chlorobenzotrifluoride, acetone, dimethyl carbonate, propylene carbonate, methyl ethyl ketone (MEK), methyl amyl ketone (MAK), methyl propyl ketone (MPK), methyl butyl ketone (MIBK), 1-methoxy-2-propyl acetate, ethyl 3-ethoxy propionate (EEP), ethylene glycol monopropyl ether, ethyl acetate, methyl acetate, water, methanol, ethanol, propanol, isopropanol, butanol, or combinations thereof. In embodiments, step 102 is omitted.

In embodiments, the method may include a step 104 of preparing a binder solution. In embodiments, the binder includes fluoroethylene vinyl ether, polyvinyl fluoride, polyvinylidene fluoride, tetrafluoroethylene, hexafluoropropylene, vinylidene fluoride, hexafluoropropylene, tetrafluoroethylene, ethylene, tetracthoxysilane, methyltriethoxysilane, dimethyldiethoxysilane, silanol terminated polydimethylsiloxane, epoxypropoxypropyl terminated polydimethylsiloxane, aminopropyl terminated polydimethylsiloxane, ethoxy terminated polydimethylsiloxane, hydride terminated polydimethylsiloxane, or combinations thereof. Preparing the binder solution may include dissolving the binder in a solvent, such as by combing the binder and the solvent, and stirring or otherwise agitating the binder and the solvent until the binder is dissolved. In embodiments, stirring may be performed for greater than or equal to about 2 minutes to less than or equal to about 15 minutes, for example, about 2 minutes, about 3 minutes, about 4 minutes, about 5 minutes, about 6 minutes, about 7 minutes, about 8 minutes, about 9 minutes, about 10 minutes, about 11 minutes, about 12 minutes, about 13 minutes, about 14 minutes, about 15 minutes, or any value contained within a range formed by any two of the preceding values. In embodiments, the solvent includes butyl acetate, ethyl acetate, methanol, ethanol, propanol, isopropanol, or combinations thereof. In embodiments, step 104 is omitted.

In embodiments, the method includes a step 106 of preparing a coating solution including a binder and a hydrophobic compound. In embodiments, the method may omit step 102 and step 104, and in such embodiments, step 106 may include combining the binder and the hydrophobic compound in the solvent. In embodiments, the solvent may include N-methylpyrrolidone, N-dimethylformamide, N,N-dimethylacetamide, xylene, n-butyl acetate, t-butyl acetate, p-chlorobenzotrifluoride, acetone, dimethyl carbonate, propylene carbonate, methyl ethyl ketone (MEK), methyl amyl ketone (MAK), methyl propyl ketone (MPK), methyl butyl ketone (MIBK), 1-methoxy-2-propyl acetate, ethyl 3-ethoxy propionate (EEP), ethylene glycol monopropyl ether, ethyl acetate, methyl acetate, water, methanol, ethanol, propanol, isopropanol, butanol, butyl acetate, or combinations thereof. In embodiments, step 106 may further include stirring, ultrasonication, heating, or combinations thereof, to prepare the coating solution. Step 106 may include stirring, ultrasonication, heating, or combinations thereof for a time of greater than or equal to about 5 minutes to less than or equal to about 30 minutes, such as about 5 minutes, about 10 minutes, about 15 minutes, about 20 minutes, about 25 minutes, about 30 minutes, or any value contained within a range formed by any two of the preceding values.

In other embodiments, the method may include step 102, and in such embodiments, step 106 may include combining the hydrophobic solution prepared in step 102 with a binder. In embodiments of the method which include step 102, step 106 may include combining the hydrophobic solution with the binder directly, or step 106 may include the addition of solvent with the binder as described herein.

In embodiments, the method may include step 104, and in such embodiments, step 106 may include combining the binder solution prepared in step 104 with a composition having hydrophobic moieties. In embodiments of the method which include step 104, step 106 may include combining the binder solution with the hydrophobic compound directly, or step 106 may include the addition of solvent with the hydrophobic compound as described herein.

In embodiments, the method may include step 102 and step 104, and in such embodiments, step 106 may include combining the hydrophobic solution prepared in step 102 with the binder solution prepared in step 104.

In embodiments, the method includes a step 108 of depositing the coating solution onto a substrate. In embodiments, the substrate to which the coating composition is applied is not particularly limited. The surface may include a metal, a metallic alloy, glass, plastic, polymer, or combinations thereof. In embodiments, the substrate may be a solar panel, a wind turbine, an automotive or aerospace vehicle, a window, or other surface in need of a superhydrophobic and transparent coating. In embodiments, depositing the coating solution onto the substrate includes spray coating, dip coating, inkjet printing, spin coating, slot-die coating, blade coating, drop casting, brush painting, or combinations thereof. In embodiments, the coating solution is applied by using a sprayer, wherein the speed and pressure of the sprayer is not particularly limited and may be varied or held constant throughout application. In embodiments, step 108 may include the deposition of the coating solution in one portion, or in multiple portions, such that multiple layers of the coating composition are deposited. In embodiments, step 108 may include depositing the binder solution followed by depositing the hydrophobic solution. In embodiments, step 108 is omitted, and the coating solution may be collected and stored for future use.

In any embodiments, any or all of the method steps disclosed herein may be performed at room temperature, that is, greater than or equal to about 20° C. to less than or equal to about 22° C., as will be understood by those skilled in the art.

In embodiments, the method 100 may include step 106 as described herein. In embodiments, the method 100 may include step 106 and step 108 as described herein. In embodiments, the method 100 may include step 102 and step 106 as described herein. In embodiments, the method 100 may include step 102, step 106, and step 108 as described herein. In embodiments, the method 100 may include step 104 and step 106 as described herein. In embodiments, the method 100 may include step 104, step 106, and step 108 as described herein. In embodiments, the method 100 may include step 102, step 104, and step 106 as described herein. In embodiments, the method 100 may include step 102, step 104, and step 108 as described herein. In embodiments, the method 100 may include step 102, step 104, step 106, and step 108 as described herein.

In embodiments, there is provided a coating composition including a binder, a hydrophobic compound, and a solvent. In embodiments, the hydrophobic compound includes a compound which has hydrophobic moieties. In embodiments, the coating composition is transparent and hydrophobic. In embodiments, the coating composition is transparent and superhydrophobic. In embodiments, the coating composition is processable at room temperature.

In embodiments, the coating composition includes greater than or equal to about 10 wt. % to less than or equal to about 80 wt. % of the binder, such as about 10 wt. %, about 20 wt. %, about 30 wt. %, about 40 wt. %, about 50 wt. %, about 60 wt. %, about 70 wt. %, about 80 wt. %, or any value contained within a range formed by two of the preceding values. In embodiments, the binder includes a fluoropolymer, an organically modified silicate, a functional polydimethylsiloxane copolymer, or combinations thereof. In embodiments, the binder includes fluoroethylene vinyl ether, polyvinyl fluoride, polyvinylidene fluoride, tetrafluoroethylene, hexafluoropropylene, vinylidene fluoride, hexafluoropropylene, tetrafluoroethylene, ethylene, tetraethoxysilane, methyltriethoxysilane, dimethyldiethoxysilane, silanol terminated polydimethylsiloxane, epoxypropoxypropyl terminated polydimethylsiloxane, aminopropyl terminated polydimethylsiloxane, ethoxy terminated polydimethylsiloxane, hydride terminated polydimethylsiloxane, or combinations thereof.

In embodiments, the coating composition includes greater than or equal to about 0.01 wt. % to less than or equal to about 7 wt. % of the hydrophobic compound, such as about 0.01 wt. %, about 0.05 wt. %, about 0.1 wt. %, about 0.5 wt. %, about 1 wt. %, about 1.5 wt. %, about 2 wt. %, about 2.5 wt. %, about 3 wt. %, about 3.5 wt. %, about 4 wt. %, about 4.5 wt. %, about 5 wt. %, about 5.5 wt. %, about 6 wt. %, about 6.5 wt. %, about 7 wt. %, or any value contained within a range formed by two of the preceding values. The amount of the hydrophobic compound included in the coating composition may be adjusted within the above range to maintain the transparency of the coating composition.

In embodiments, the hydrophobic compound contributes to the superhydrophobicity of the coating composition, without wishing to be bound by theory. In embodiments, the hydrophobic compound includes silicon dioxide nanostructures, titanium dioxide nanostructures, zinc oxide nanostructures, aluminum oxide nanostructures, aluminosilicates, dimethyldiethoxysilane, trimethylethoxysilane, bis(trimethylsilyl) amine, isooctyltriethoxysilane, octadecyltriethoxysilane, dodecyldimethylethoxysilane, (3,3,3-trifluoropropyl) trimethoxysilane, (heptadecafluoro-1,1,2,2-tetrahydrodecyl) triethoxysilane, or combinations thereof. In embodiments, the hydrophobic compound includes nanostructures which have been functionalized with hydrophobic agents prior to incorporation into the coating composition of the present disclosure. In embodiments, the functionalization with fluoro- or alkyl-surface groups increases the hydrophobic character of the nanostructures, which increases the superhydrophobic character of the coating composition, without wishing to be bound by theory.

In embodiments, the coating composition includes a solvent. In embodiments, the solvent allows the hydrophobic compound and the binder to evenly disperse to form a uniform and homogenous coating composition. The solvent may include N-methylpyrrolidone, N-dimethylformamide, N,N-dimethylacetamide, xylene, n-butyl acetate, t-butyl acetate, p-chlorobenzotrifluoride, acetone, dimethyl carbonate, propylene carbonate, methyl ethyl ketone (MEK), methyl amyl ketone (MAK), methyl propyl ketone (MPK), methyl butyl ketone (MIBK), 1-methoxy-2-propyl acetate, ethyl 3-ethoxy propionate (EEP), ethylene glycol monopropyl ether, ethyl acetate, methyl acetate, water, methanol, ethanol, propanol, isopropanol, butanol, butyl acetate, or combinations thereof. In embodiments, the coating composition includes greater than or equal to about 10 wt. % to less than or equal to about 90 wt. % of the solvent, for example, about 10 wt. %, about 20 wt. %, %, about 30 wt. %, about 40 wt. %, about 50 wt. %, about 60 wt. %, about 70 wt. %, about 80 wt. %, about 90 wt. %, or any value contained within a range formed by two of the preceding values.

In embodiments, the coating composition described herein includes a hydrophobic compound, a binder, and a solvent in the above-described amounts such that the total composition adds up to 100 wt. %. For example, in embodiments, the coating composition can include about 1 wt. % hydrophobic moieties, up to 20 wt. % binder, and no less than 79 wt. % solvent. This example is non-limiting and other embodiments containing other weight percentages, as described herein, of the above-described compounds are also contemplated.

In embodiments, it is desirable to include a small amount of the hydrophobic compound and a large amount of the binder to maintain transparency (which is provided by the binder) while achieving the hydrophobicity or superhydrophobicity imparted by the hydrophobic compound, without wishing to be bound by theory. The amount of solvent may be selected to solubilize and homogenize the hydrophobic compound and the binder such that the coating composition may be applied evenly and easily via spraying or other deposition methods. It is particularly contemplated that the amounts of hydrophobic compound, binder, and solvent may be selected to allow the room-temperature deposition of the coating composition. That is, the coating composition is, in embodiments, processable at room temperature.

In embodiments, the coating composition described herein has a contact angle of greater than or equal to about 90° to less than or equal about 180°, such as about 90°, about 100°, about 110°, about 120°, about 130°, about 140°, about 150°, about 160°, about 170°, about 180°, or any value contained within a range formed by two of the preceding values. In embodiments, the coating composition is hydrophobic and has a contact angle of greater than or equal to about 90°. In embodiments, the coating composition is superhydrophobic and has a contact angle of greater than or equal to about 150°.

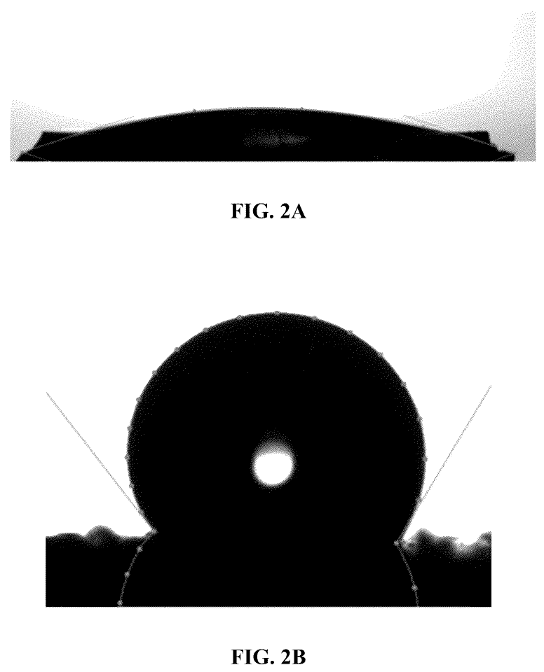

FIG. 2A is an image of a water droplet on nonfunctionalized nanoparticles and FIG. 2B is an image of a water droplet on functionalized nanoparticles with hydrophobic moieties, according to an embodiment of the present disclosure. As shown in FIG. 2A and FIG. 2B, the coating with non-functionalized nanoparticles exhibits a contact angle of 15.3°, while the coating of the present disclosure which includes functionalized nanoparticles exhibits a contact angle of 125.4°, demonstrating the hydrophobicity of the present coating composition.

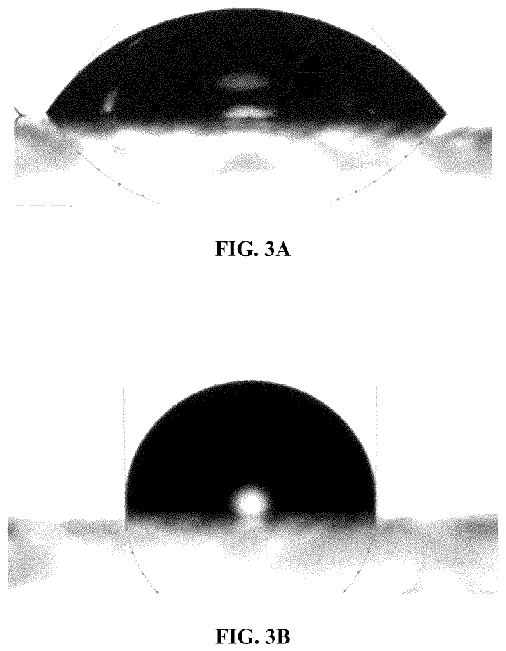

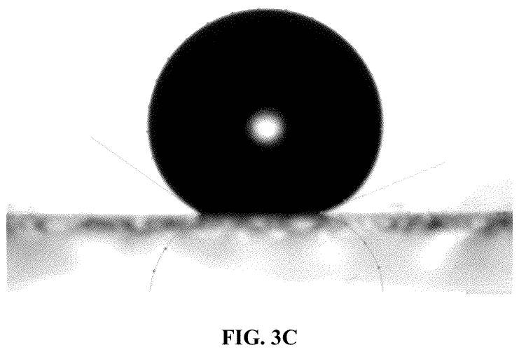

FIG. 3A is an image of a water droplet on a bare glass substrate, FIG. 3B is an image of a water droplet on a glass substrate coated with a hydrophobic coating composition, and FIG. 3C is an image of a water droplet on a glass substrate coated with a superhydrophobic coating composition, according to embodiments of the present disclosure. The bare glass in FIG. 3A exhibits a contact angle of 50.31°, the hydrophobic coating in FIG. 3B exhibits a contact angle of 90.70°, and the superhydrophobic coating in FIG. 3C exhibits a contact angle of 151.06°.

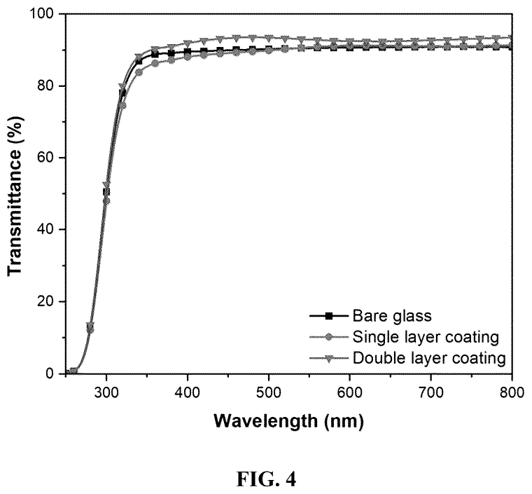

In embodiments, the coating composition described herein is transparent. Transparency may be measured by UV-visible spectroscopy or by other methods known to those skilled in the art. In embodiments, the coating composition of the present disclosure has a greater transmittance of greater than or equal to about 95%, for example the transmittance of the coating composition may be at least about 95%, at least about 96%, at least about 97%, at least about 98%, at least about 99%, or about 100%. FIG. 4 is a graph of transmittance (%) of bare glass compared to a single- and double-layered coating as described herein on glass, according to an embodiment of the present disclosure. As shown in FIG. 4, the double layered coating of the present disclosure exhibits the highest transmittance, which can be considered a measure of transparency. In embodiments, the coating composition which achieves at least about 95% transmittance may have a thickness of less than or equal to about 50 μm, such as about 50 μm, about 40 μm, about 30 μm, about 20 μm, about 10 μm, about 5 μm, about 4 μm, about 3 μm, about 2 μm, about 1 μm, or any value contained within a range formed by any two of the preceding values.

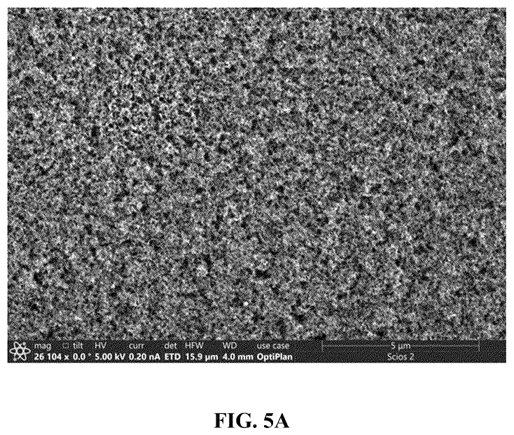

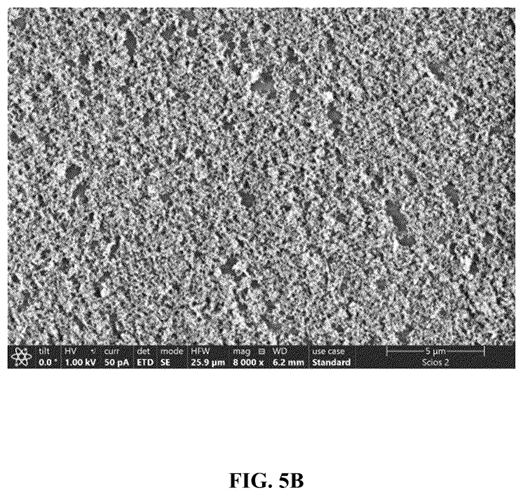

FIG. 5A is a SEM image of the top morphology of a representative sample of the hydrophobic coating prepared with a fluoropolymer-based binder, and FIG. 5B is a SEM image of the top morphology of a representative sample of the hydrophobic coating prepared with an organically-modified silica-based binder, according to embodiments of the present disclosure. FIG. 5A and FIG. 5B show the morphology and nanoscale features of the coating composition of the present disclosure which promote the hydrophobicity and superhydrophobicity observed from the coating composition, without wishing to be bound by theory.

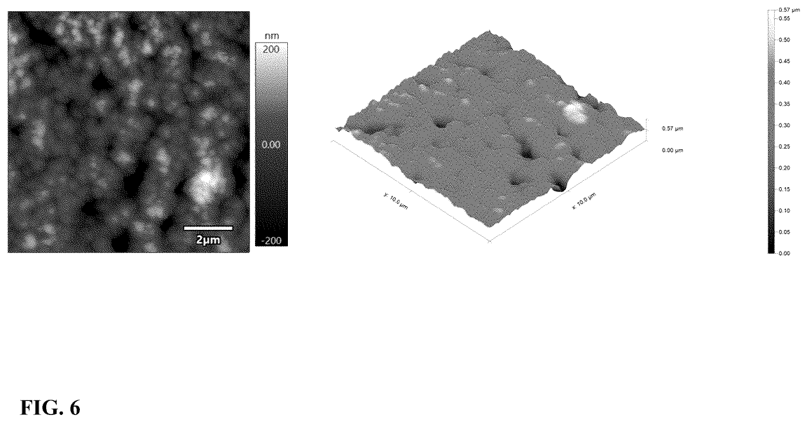

FIG. 6 is an image of the top morphology captured by AFM of a representative sample of the coating at nanometer and micrometer scale, according to an embodiment of the present disclosure. FIG. 6 further demonstrates the morphology of the coating composition of the present disclosure.

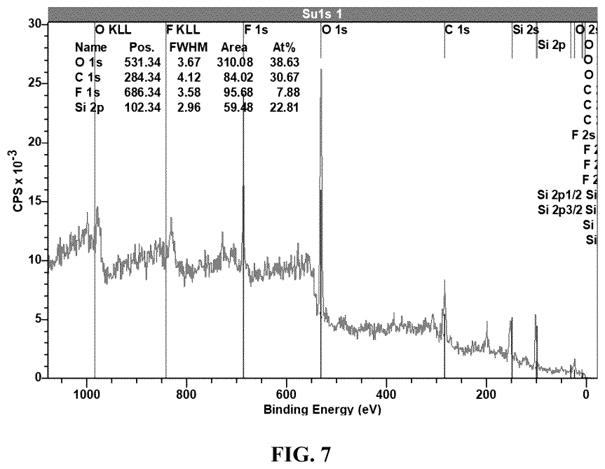

FIG. 7 is an XPS spectrum of a representative single layer sample of the coating, according to an embodiment of the present disclosure. The coating shown in FIG. 7 was formulated with fluoropolymers, as described herein. As shown in FIG. 7, the XPS spectrum confirms the composition and types of bonds present in the coating composition of the present disclosure.

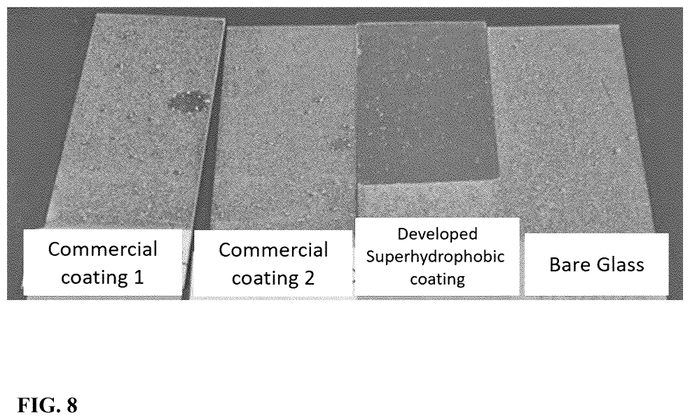

FIG. 8 is an image of the dust-repellence effect of a representative sample of the coating according to an embodiment of the present disclosure, compared to a bare glass and glass coated with hydrophobic commercial coatings over a certain period of outdoor exposure. FIG. 8 demonstrates the superior dust-repellence of the presently disclosed coating compared to bare glass and commercially available coatings.

In embodiments, there is provided a method of providing a transparent and hydrophobic or superhydrophobic coating to a surface which includes applying a coating composition which comprises a hydrophobic compound, a binder, and a solvent to the surface. In embodiments, the coating composition is a coating composition as described herein. In embodiments, the hydrophobic compound, the binder, and the solvent are present in the coating composition in the amounts described herein. In embodiments, the coating composition is transparent and hydrophobic. In embodiments, the coating composition is transparent and superhydrophobic.

In embodiments, the surface to which the coating composition is applied is not particularly limited. The surface may include a metal, a metallic alloy, glass, plastic, ceramics, polymer, fabrics, wood, concrete, or combinations thereof. In embodiments, the surface may be a solar panel, a wind turbine, an automotive or aerospace vehicle, a window, or other surface in need of a hydrophobic and superhydrophobic transparent coating.

In embodiments, applying the coating composition to the surface includes roll coating, drop rolling, spraying, dip coating, blade coating or flow coating. Other methods for deposition that can be used include spin-coating; aerosol deposition; ultrasound, heat, or electrical deposition means; micro-deposition techniques such as inkjet, spray-jet, xerography; or commercial printing techniques such as silk printing, dot matrix printing, the like, or combinations thereof. Deposition of the composition may be performed under ambient conditions, such as room temperature and standard pressure.

In embodiments, the coating composition may be applied to the surface multiple times, such that there are multiple layers of the coating composition. For example, a surface may be coated with the coating composition one time, two times, three times, four times, five times, and so forth, such that there is/are one layer, two layers, three layers, four layers, five layers, and so forth.

### EXAMPLES

According to some embodiments of the present disclosure, a hydrophobic or superhydrophobic and transparent coating composition was prepared. The coating composition was prepared including silicon dioxide nanoparticles, fluoroethylene vinyl ether (FEVE), and isopropyl alcohol (IPA). The coating was prepared with hydrophobic moieties of functionalized silicon dioxide nanoparticles, and the transmittance, which can be considered a measure of transparency, was measured as shown in FIG. 4, comparing a single- and double-layered coating as described herein on glass, the coating having a thickness of about 20 μm. The surface chemical composition, as determined by X-ray photoelectron spectroscopy (XPS), is shown in FIG. 7.

This disclosure is not limited to the particular systems, devices and methods described, as these may vary. The terminology used in the description is for the purpose of describing the particular versions or embodiments only and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A coating composition, comprising:
a hydrophobic compound;
a binder; and
a solvent;
wherein the coating composition is hydrophobic and transparent; and
wherein the coating composition is processable at room temperature.

2. The coating composition of claim 1, wherein the hydrophobic compound comprises silicon dioxide nanostructures, titanium dioxide nanostructures, zinc oxide nanostructures, aluminum oxide nanostructures, aluminosilicates, dimethyldiethoxysilane, trimethylethoxysilane, bis(trimethylsilyl) amine, isooctyltriethoxysilane, octadecyltriethoxysilane, dodecyldimethylethoxysilane, (3,3,3-trifluoropropyl) trimethoxysilane, (heptadecafluoro-1,1,2,2-tetrahydrodecyl) triethoxysilane, or combinations thereof.

3. The coating composition of claim 1, wherein the coating composition comprises 0.01 wt. % to 7 wt. % of the hydrophobic compound.

4. The coating composition of claim 1, wherein the binder comprises a fluoropolymer, an organically modified silicate, a functional polydimethylsiloxane copolymer, or combinations thereof.

5. The coating composition of claim 1, wherein the binder comprises fluoroethylene vinyl ether, polyvinyl fluoride, polyvinylidene fluoride, tetrafluoroethylene, hexafluoropropylene, vinylidene fluoride, hexafluoropropylene, tetrafluoroethylene, ethylene, tetraethoxysilane, methyltriethoxysilane, dimethyldiethoxysilane, silanol terminated polydimethylsiloxane, epoxypropoxypropyl terminated polydimethylsiloxane, aminopropyl terminated polydimethylsiloxane, ethoxy terminated polydimethylsiloxane, hydride terminated polydimethylsiloxane, or combinations thereof.

6. The coating composition of claim 1, wherein the coating composition comprises 10 wt. % to 90 wt. % of the binder.

7. The coating composition of claim 1, wherein the solvent comprises N-methylpyrrolidone, N-dimethylformamide, N,N-dimethylacetamide, xylene, n-butyl acetate, t-butyl acetate, p-chlorobenzotrifluoride, acetone, dimethyl carbonate, propylene carbonate, methyl ethyl ketone, methyl amyl ketone, methyl propyl ketone, methyl butyl ketone, 1-methoxy-2-propyl acetate, ethyl 3-ethoxy propionate, ethylene glycol monopropyl ether, ethyl acetate, methyl acetate, water, methanol, ethanol, propanol, isopropanol, butanol, butyl acetate, or combinations thereof.

8. The coating composition of claim 1, wherein the coating composition comprises about 10 wt. % to about 90 wt. % of the solvent.

9. The coating composition of claim 1, wherein the coating composition has a contact angle between greater than or equal to 90° and less than or equal to 180°.

10. The coating composition of claim 1, wherein the coating composition is superhydrophobic.

11. The coating composition of claim 1, wherein the coating composition has a transmittance of greater than or equal to 95%.

12. A method of making a coating composition, comprising:
providing a binder and a hydrophobic compound; and
preparing a coating solution comprising the binder, the hydrophobic compound, and a solvent.

13. The method of claim 12, wherein the binder comprises fluoroethylene vinyl ether, polyvinyl fluoride, polyvinylidene fluoride, tetrafluoroethylene, hexafluoropropylene, vinylidene fluoride, hexafluoropropylene, tetrafluoroethylene, ethylene, tetraethoxysilane, methyltriethoxysilane, dimethyldiethoxysilane, silanol terminated polydimethylsiloxane, epoxypropoxypropyl terminated polydimethylsiloxane, aminopropyl terminated polydimethylsiloxane, ethoxy terminated polydimethylsiloxane, hydride terminated polydimethylsiloxane, or combinations thereof.

14. The method of claim 12, wherein the hydrophobic compound comprises silicon dioxide nanostructures, titanium dioxide nanostructures, zinc oxide nanostructures, aluminum oxide nanostructures, aluminosilicates, dimethyldiethoxysilane, trimethylethoxysilane, bis(trimethylsilyl) amine, isooctyltriethoxysilane, octadecyltriethoxysilane, dodecyldimethylethoxysilane, (3,3,3-trifluoropropyl) trimethoxysilane, (heptadecafluoro-1,1,2,2-tetrahydrodecyl) triethoxysilane, or combinations thereof.

15. The method of claim 12, wherein the solvent comprises N-methylpyrrolidone, N-dimethylformamide, N,N-dimethylacetamide, xylene, n-butyl acetate, t-butyl acetate, p-chlorobenzotrifluoride, acetone, dimethyl carbonate, propylene carbonate, methyl ethyl ketone, methyl amyl ketone, methyl propyl ketone, methyl butyl ketone, 1-methoxy-2-propyl acetate, ethyl 3-ethoxy propionate, ethylene glycol monopropyl ether, ethyl acetate, methyl acetate, water, methanol, ethanol, propanol, isopropanol, butanol, butyl acetate, or combinations thereof.

16. The method of claim 12, further comprising preparing a hydrophobic solution comprising the hydrophobic compound and the solvent.

17. The method of claim 16, wherein preparing the coating solution comprises combining the binder with the hydrophobic solution.

18. The method of claim 12, further comprising preparing a binder solution comprising the binder and the solvent.

19. The method of claim 18, wherein preparing the coating solution comprises combining the hydrophobic compound with the binder solution.

20. The method of claim 12, wherein preparing the coating solution comprises combining a solution of the binder in the solvent with a solution of the hydrophobic compound in the solvent.

21. The method of claim 12, wherein preparing the coating solution comprises combining the binder and the hydrophobic compound in the solvent.

22. A method of providing a transparent and hydrophobic coating to a surface, comprising:
applying a coating composition which comprises a hydrophobic compound, a binder, and a solvent to the surface.

23. The method of claim 22, wherein the surface comprises a metal, a metallic alloy, glass, plastic, ceramics, polymer, fabrics, wood, concrete, or combinations thereof.

24. The method of claim 22, wherein the hydrophobic compound comprises silicon dioxide nanostructures, titanium dioxide nanostructures, zinc oxide nanostructures, aluminum oxide nanostructures, aluminosilicates, dimethyldiethoxysilane, trimethylethoxysilane, bis(trimethylsilyl) amine, isooctyltriethoxysilane, octadecyltriethoxysilane, dodecyldimethylethoxysilane, (3,3,3-trifluoropropyl) trimethoxysilane, (heptadecafluoro-1,1,2,2-tetrahydrodecyl) triethoxysilane, or combinations thereof.

25. The method of claim 22, wherein the binder comprises fluoroethylene vinyl ether, polyvinyl fluoride, polyvinylidene fluoride, tetrafluoroethylene, hexafluoropropylene, vinylidene fluoride, hexafluoropropylene, tetrafluoroethylene, ethylene, tetraethoxysilane, methyltriethoxysilane, dimethyldiethoxysilane, silanol terminated polydimethylsiloxane, epoxypropoxypropyl terminated polydimethylsiloxane, aminopropyl terminated polydimethylsiloxane, ethoxy terminated polydimethylsiloxane, hydride terminated polydimethylsiloxane, or combinations thereof.

26. The method of claim 22, wherein the solvent comprises N-methylpyrrolidone, N-dimethylformamide, N,N-dimethylacetamide, xylene, n-butyl acetate, t-butyl acetate, p-chlorobenzotrifluoride, acetone, dimethyl carbonate, propylene carbonate, methyl ethyl ketone, methyl amyl ketone, methyl propyl ketone, methyl butyl ketone, 1-methoxy-2-propyl acetate, ethyl 3-ethoxy propionate, ethylene glycol monopropyl ether, ethyl acetate, methyl acetate, water, methanol, ethanol, propanol, isopropanol, butanol, butyl acetate, or combinations thereof.

27. The method of claim 22, wherein applying the coating composition to the surface comprises roll coating, drop rolling, spraying, dip coating, blade coating, flow coating, spin-coating, aerosol deposition, ultrasound deposition, electrical deposition, inkjet printing, spray-jet printing, xerography, silk printing, dot matrix printing, or combinations thereof.

28. The method of claim 22, wherein the coating composition is applied at room temperature.

29. The method of claim 22. wherein the coating composition is superhydrophobic.
